(19) United States
(12) Patent Application Publication
(10) Pub. No.: US 2019/0220860 A1
(43) Pub. Date: Jul. 18, 2019

(54) System Facilitating License Of Intellectual Property

(71) Applicant: Wesley W. Whitmyer, JR., Stamford, CT (US)

(72) Inventor: Wesley W. Whitmyer, JR., Stamford, CT (US)

(21) Appl. No.: 16/248,436

(22) Filed: Jan. 15, 2019

Related U.S. Application Data
(60) Provisional application No. 62/639,314, filed on Mar. 6, 2018.
(60) Provisional application No. 62/618,051, filed on Jan. 16, 2018.

(51) Int. Cl. G06Q 20/40; G06F 21/10; G06Q 20/36

(52) U.S. Cl. CPC G06Q 20/40; G06F 2221/0768; G06Q 20/3678; G06F 21/10

(57) ABSTRACT

A system facilitating license of intellectual property includes a computing platform, a plurality of intellectual properties available to license, a plurality of ownership verifications submitted to the computing platform by the owners of each of the plurality of intellectual properties, a plurality of public keys representing payment addresses associated with each of the verified owners for each of the plurality of intellectual properties, a database accessible by the computing platform for storing at least a reference to each of the intellectual properties and their associated public keys, a remote display for presenting the intellectual properties together with the public keys of their associated owners, a payment made by the computing platform to each of the verified owners' public keys upon presentation of each their intellectual properties on the remote display, and a ledger for recording the payments.

### CROSS-REFERENCE TO RELATED APPLICATIONS

This patent application claims the benefit, under 35 U.S.C. § 119(e), of U.S. Provisional Patent Application No. 62/618,051, filed Jan. 16, 2018. This patent application also claims the benefit, under 35 U.S.C. § 119(e), of U.S. Provisional Patent Application No. 62/639,314, filed Mar. 6, 2018. The contents of all prior applications are hereby incorporated by reference in their entirety.

### TECHNICAL FIELD

Aspects of the present invention generally relate to a system facilitating license of intellectual property.

### BACKGROUND

The purpose of intellectual property (IP) is to provide a measure of legal protection to creative endeavor as an incentive for innovation. However, this regime is often criticized for at least the reason that the costs associated with infringement actions prevent technology adoption and divert resources that could otherwise be deployed for innovation.

A number of attempts have been made to alter the playing field, including IP pools, changes to statutory law, judicial intervention for mandatory licensing, IP enforcement entities, and IP marketplaces. None of these proposals has provided an open market (e.g., centralized and/or decentralized) on which IP rights can be licensed at a reasonable price with the costs associated with lawyers, courts or other forms of centralized control, which also provides value and recognition to IP rights holders.

Aspects of the present invention are directed to these and other problems.

### SUMMARY

According to an aspect of the present invention, a system facilitating license of IP is provided that includes a computing platform, a plurality of intellectual properties available to license, a plurality of ownership verifications submitted to the computing platform by the owners of each of the plurality of intellectual properties, a plurality of public keys representing payment addresses associated with each of the verified owners for each of the plurality of intellectual properties, a database accessible by the computing platform for storing at least a reference to each of the intellectual properties and their associated public keys, a remote display for presenting the intellectual properties together with the public keys of their associated owners, a payment made by the computing platform to each of the verified owners' public keys upon presentation of each their intellectual properties on the remote display, and a ledger for recording the payments.

In addition to, or as an alternative to, one or more of the features described above, further aspects of the present invention can include one or more of the following features, individually or in combination:
the computing platform includes a server function;
the remote display includes a browser function;
the ownership verification is provided as a personal verification of the inventor;
the ownership verification is provided as evidence of a recorded assignment;
the public key payment addresses are provided as crypto currency wallets;
the payment is made with a token;
the payment is made with an Ethereum token;
the payment is made with a crypto currency;
the cryptocurrency is selected from the group comprising: Bitcoin and Ethereum;
the ledger is public;
the ledger is a blockchain;
the ledger is private;
the ledger is recorded on a blockchain;
at least one of the intellectual properties is a patent;
the remote display is utilized to cause the computing platform to search the database for IP of interest to license;
the remote display also presents a license fee required to license the IP of interest;
the license fee includes a multiple of the payment;
the license fee is calculated as a function of one or more of the following factors: duration, jurisdiction, recognition, multiplier and combinations of these;
the jurisdiction license fee factor is scaled according to market size;
the recognition license fee factor is scaled according to peer review of the IP;
the recognition license fee factor is scaled according to number of forward citations of the patent;
the multiplier license fee factor is scaled according to the technical field of the patent;
the license fee is paid to the public key of the verified owner of the IP of interest;
the license fee is received in a wallet of the verified owner of the licensed IP;
the IP license is anonymously memorialized on a public record;
the license fee is paid with a token;
the license fee is paid with a cryptocurrency;
the computing platform exchanges token for cryptocurrency;
the computing platform exchanges fiat for token;
the license fee is paid with a mobile application;
the remote display is a mobile computing device;
the public key is provided on the remote display as a QR code;
the computing platform provides a link to the remote display for downloading a certificate of license to the IP of interest;
the computing platform is Ethereurn;
blockchain is Ethereum blockchain; and
the wallet is an Ethereum wallet.

These and other aspects of the present invention will become apparent in light of the drawings and detailed description provided below.

### BRIEF DESCRIPTION OF THE DRAWINGS

FIG. 1 illustrates the present system.

FIG. 2 illustrates the present system during use by multiple IP owners with multiple intellectual properties, etc.

### DETAILED DESCRIPTION

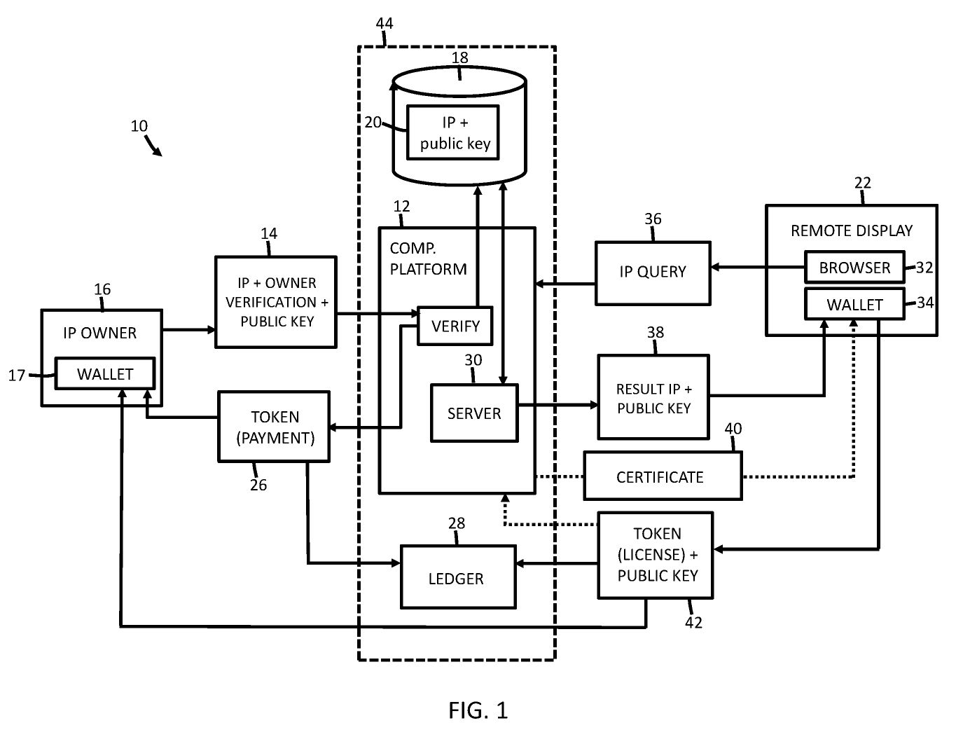

Referring to FIG. 1, the present disclosure describes a system 10 facilitating license of IP.

Referring to FIG. 1, the system 10 includes: a computing platform 12; an owner input 14 submitted to the computing platform 12 by an IP owner 16, the owner input 14 including an IP available to license, an ownership verification, and a public key representing a payment address associated with the verified owner of the IP (hereinafter the “IP owner's public key”); a database 18 accessible by the computing platform 12 and configured to store a reference 20 to the IP and the IP owner's public key; a remote display 22 configured to present the IP together with the IP owner's public key; a payment 26 made by the computing platform 12 to the IP owner's public key upon presentation of the IP owned by the IP owner 16 on the remote display 22; and a ledger 28 for recording the at least one payment 26.

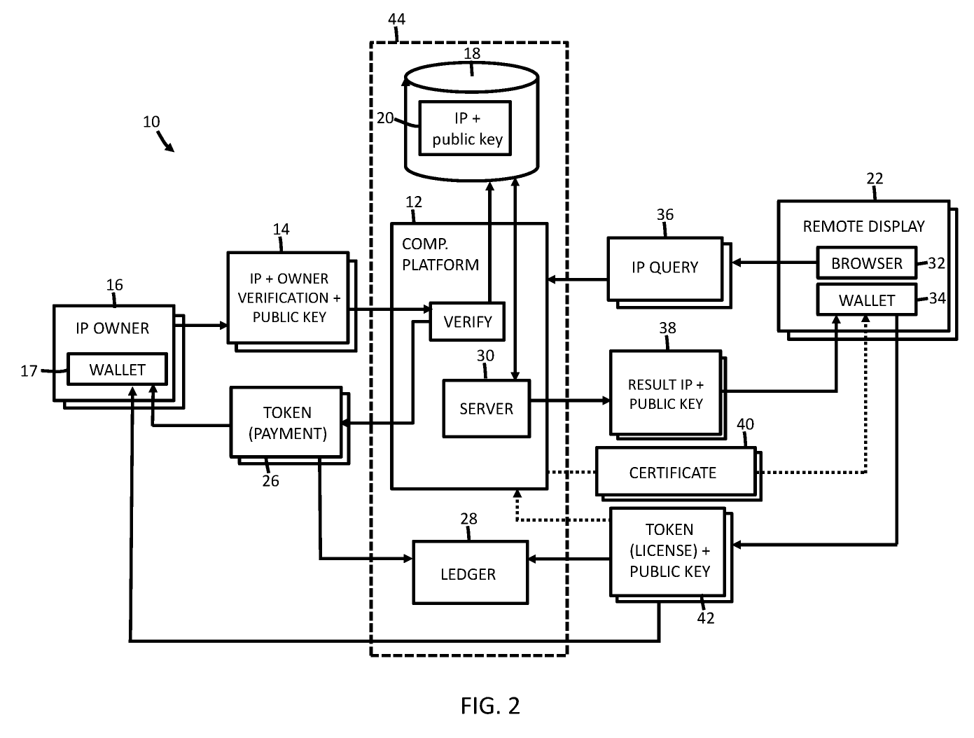

For ease of discussion, the system 10 is described relative to FIG. 1, which shows only a single IP owner 16, a single IP owner input 14, etc. However, in practice the system 10 will typically include a plurality of IP owners 16, a plurality of IP owner inputs 14, etc., as shown in FIG. 2.

Referring again to FIG. 1, the computing platform 12 includes a server 30 and provides a link to the remote display 22. The remote display 22 (e.g., a mobile device) includes a browser 32 and a wallet 34.

An IP query 36 can be submitted from the remote display 22 to the computing platform 12, which causes the computing platform 12 to search the server 30 and associated database 18 for an IP of interest to license.

The computing platform 12 can send a link 38 to the remote display 22 for viewing by a user, the link 38 including a result IP of interest and the IP owner's public key. In some embodiments, the link 38 and/or the IP owner's public key is provided on the remote display 22 as a QR code. The IP available to license is one or more of a patent, a trademark, a copyright, a trade secret, and another type of IP. The IP can be registered in one or more countries.

The computing platform 12 provides the link 38 and an optional license certificate 40 to a user in exchange for a license fee 42. The license fee 42 can be made in the form of a token (e.g., a token built on Ethereum), a cryptocurrency (e.g., Bitcoin), and/or another type of digital asset. The license fee 42 is paid to the IP owner's public key, and the IP license is anonymously memorialized on the ledger 28.

In some embodiments, the license fee 42 includes a multiple of the payment 26. The license fee 42 can be calculated as a function of one or more of the following factors: duration, jurisdiction, recognition, multiplier and combinations of these. The jurisdiction license fee factor can be scaled according to market size. The recognition license fee factor can be scaled according to peer review of the IP. The recognition license fee factor can be scaled according to number of forward citations of the IP. The multiplier license fee factor can be scaled according to the technical field of the IP.

The computing platform 12 can be configured to exchange a token (e.g., token built on Ethereum) to fiat, another token (e.g., token built on Ethereum), a crypto currency (e.g., Bitcoin) and/or another type of digital asset.

In some embodiments, one or more of the computing platform 12, the database 18, and the ledger 28 collectively form a decentralized network 44. In some such embodiments, the computing platform 12 is Ethereum and/or built on the Ethereum platform.

The ownership verification included in the IP owner input 14 includes a personal verification of ownership and/or creatorship of the respective IP by the IP owner 16. In some embodiments, the IP owner input 14 provides evidence of a recorded assignment to the IP owner 16. In some embodiments, the IP owner's public key is a public key of a crypto currency wallet 17.

The payment 26 is sent to the owner of the IP after the computing platform 12 receives the IP owner input 14 and verifies ownership of the IP by the IP owner 16. The payment 26 can be made in the form of a token (e.g., an Ethereum token), a cryptocurrency (e.g., Bitcoin), and/or another type of digital asset.

The ledger 28 is at least one of a public ledger, a private ledger, a blockchain, and/or data recorded on a blockchain.

The present disclosure describes aspects of the invention with reference to the exemplary embodiment illustrated in the drawing; however, aspects of the invention are not to be restricted in light of the exemplary embodiment illustrated in the drawing. It will be apparent to those of ordinary skill in the art that aspects of the invention include many more embodiments, and many variations and modifications can be made without departing from the true scope of the present disclosure. For example, in some instances, one or more features disclosed in connection with one embodiment can be used alone or in combination with one or more features of one or more other embodiment.

What is claimed is:

1. A system facilitating license of intellectual property, comprising:
a computing platform;
a plurality of intellectual properties available to license;
a plurality of ownership verifications submitted to the computing platform by the owners of each of the plurality of intellectual properties;
a plurality of public keys representing payment addresses associated with each of the verified owners for each of the plurality of intellectual properties;
a database accessible by the computing platform for storing at least a reference to each of the intellectual properties and their associated public keys;
a remote display for presenting the intellectual properties together with the public keys of their associated owners;
a payment made by the computing platform to each of the verified owners' public keys upon presentation of each their intellectual properties on the remote display; and
a ledger for recording the payments.

2. The system of claim 1, wherein the computing platform includes a server function.

3. The system of claim 1, wherein the remote display includes a browser function.

4. The system of claim 1, wherein the ownership verification is provided as a personal verification of the inventor.

5. The system of claim 1, wherein the ownership verification is provided as evidence of a recorded assignment.

6. The system of claim 1, wherein the public key payment addresses are provided as crypto currency wallets.

7. The system of claim 1, wherein the payment is made with a token.

8. The system of claim 7, wherein the payment is made with an Ethereum token.

9. The system of claim 1, wherein the payment is made with a crypto currency.

10. The system of claim 9, wherein the cryptocurrency is selected from the group comprising: Bitcoin and Ethereum.

11. The system of claim 1, wherein the ledger is public.

12. The system of claim 11, wherein the ledger is a blockchain.

13. The system of claim 1, wherein the ledger is private.

14. The system of claim 13, wherein the ledger is recorded on a blockchain.

15. The system of claim 1, wherein at least one of the intellectual properties is a patent.

16. The system of claim 1, wherein the remote display is utilized to cause the computing platform to search the database for intellectual property of interest to license.

17. The system of claim 16, wherein the remote display also presents a license fee required to license the intellectual property of interest.

18. The system of claim 17, wherein the license fee includes a multiple of the payment.

19. The system of claim 17, wherein the license fee is calculated as a function of one or more of the following factors: duration, jurisdiction, recognition, multiplier and combinations of these.

20. The system of claim 19, wherein the jurisdiction license fee factor is scaled according to market size.

21. The system of claim 19, wherein the recognition license fee factor is scaled according to peer review of the intellectual property.

22. The system of claim 19, wherein the recognition license fee factor is scaled according to number of forward citations of the patent.

23. The system of claim 19, wherein the multiplier license fee factor is scaled according to the technical field of the patent.

24. The system of claim 19, wherein the license fee is paid to the public key of the verified owner of the intellectual property of interest.

25. The system of claim 19, wherein the license fee is received in a wallet of the verified owner of the licensed intellectual property.

26. The system of claim 19, wherein the intellectual property license is anonymously memorialized on a public record.

27. The system of claim 19, wherein the license fee is paid with a token.

28. The system of claim 19, wherein the license fee is paid with a cryptocurrency.

29. The system of claim 19, wherein the computing platform exchanges token for cryptocurrency.

30. The system of claim 29, wherein the computing platform exchanges fiat for token.

31. The system of claim 17, wherein the license fee is paid with a mobile application.

32. The system of claim 1, wherein the remote display is a mobile computing device.

33. The system of claim 32, wherein the public key is provided on the remote display as a QR code.

34. The system of claim 32, wherein the computing platform provides a link to the remote display for downloading a certificate of license to the intellectual property of interest.

35. The system of claim 1, wherein the computing platform is Ethereum.

36. The system of claim 1, wherein blockchain is Ethereum blockchain.

37. The system of claim 1, wherein the wallet is an Ethereum wallet.
